(19) United States
(12) Patent Application Publication
(10) Pub. No.: US 2015/0362758 A1
(43) Pub. Date: Dec. 17, 2015

(54) VENTILATION STRUCTURE OF EYEGLASSES

(71) Applicant: PROHERO GROUP CO., LTD., TAINAN CITY (TW)

(72) Inventor: PEN-WEI CHEN, TAINAN CITY (TW)

(21) Appl. No.: 14/303,765

(22) Filed: Jun. 13, 2014

(51) Int. Cl. G02C 11/08; G02C 1/04; G02C 1/06

(52) U.S. Cl. CPC G02C 11/08; G02C 1/06; G02C 1/04

(57) ABSTRACT

A ventilation structure of eyeglasses is revealed. It comprises a spectacle frame having a lens assembly portion, a concave slot extended from a peripheral edge of the lens assembly portion for engaging with a lens, and a plurality of air guide channels formed in the concave slot, wherein each of the plurality of air guide channels is extended from an opening of the concave slot, pass front and rear sidewalls of the concave slot and towards a base of the concave slot for communicating with the concave slot.

### BACKGROUND OF THE INVENTION

1. Field of the Invention

The present invention relates to a ventilation structure of eyeglasses. It comprises a plurality of air guide channels formed in a concave slot for engaging with a lens to direct air flow over the lens, so as to remove fog on the lens.

2. Description of Related Art

Eyeglasses (e.g. goggles and the like) are generally used to protect users' eyes from wind, snow, or hit by foreign objects in activities, e.g. riding motorcycles and bicycles or skiing. A traditional goggle comprises a spectacle frame which fits relatively close to a user's face and covers around the user's eyes. The spectacle frame is further provided with a lens assembly portion on its front surface for engaging a lens and limiting the lens in position, and a plurality of ventilation apertures disposed on an upper border and a lower border at a rear of the lens assembly portion.

Accordingly, shielded by the lens, users' eyes keep away from an attack of wind, snow, or foreign objects, allowing users to see the surroundings clearly. Moreover, the plurality of ventilation apertures permit hot vapors released from users' skin or breathing to dissipate, so the problem of fogging due to hot vapors accumulation inside the eyeglasses can be solved. However, the plurality of ventilation apertures is disposed at the rear of the lens assembly portion, which has a distance from the lens. Once fog is generated on the lens, it cannot dissipate immediately so that users' sight and safety in activities are affected. Furthermore, the plurality of ventilation apertures is directly exposed in the external of the spectacle frame so that the spectacle frame does not have a pleasing appearance. Therefore, eyeglasses equipped with ventilation apertures are worn by users only in riding motorcycles and bicycles or skiing. People usually need purchase another pair of eyeglasses for use in usual, resulting in economic burden and inconvenience of users.

In addition, rainwater often infiltrates into the spectacle frame through the ventilation apertures causing an inner surface of the lens covered with water vapor and obstructing users' sight. In such a case, users have to take off the eyeglasses to clean the inner surface of the lens, which also causes much inconvenience when users are engaging in activities.

### SUMMARY OF THE INVENTION

In view of the above-mentioned problems, the object of the present invention is to provide a ventilation structure of eyeglasses. It comprises a plurality of air guide channels embedded in a concave slot for engaging with a lens to direct air flow over the lens, so as to remove fog on the lens.

Disclosed herein is a ventilation structure of eyeglasses, comprising a spectacle frame having a lens assembly portion, a concave slot extended from a peripheral edge of the lens assembly portion for engaging with a lens, and a plurality of air guide channels integrally formed in the concave slot, wherein each of the plurality of air guide channels is extended from an opening of the concave slot, pass front and rear sidewalls of the concave slot and towards a base of the concave slot for communicating with the concave slot.

According to an embodiment of the present invention, the spectacle frame is a full-frame spectacle frame.

According to an embodiment of the present invention, the spectacle frame is a half-frame spectacle frame.

Accordingly, the plurality of air guide channels allows air to flow therethrough, so as to maintain a same temperature inside and outside the lens and to achieve effect of immediate defogging. Furthermore, because the plurality of air guide channels is hidden in the concave slot, an appearance of the eyeglasses equipped with a ventilation structure is identical to that of general eyeglasses. Therefore, users can wear the eyeglasses of the present invention not only in activities but also in usual, which saves costs of purchasing eyeglasses.

### BRIEF DESCRIPTION OF THE DRAWINGS

FIG. 1 is a stereogram showing a ventilation structure of eyeglasses according to the present invention;

FIG. 2 is a partially enlarged diagram showing an air guide channel formed in a concave slot according to the present invention;

FIG. 3 is a partially enlarged sectional view showing an air flow through an air guide channel according to the present invention;

FIG. 4 is another stereogram showing a ventilation structure of eyeglasses according to the present invention.

### DETAILED DESCRIPTION OF THE PREFERRED EMBODIMENT

Hereinafter, an exemplary embodiment of the present invention will be described in detail with reference to the accompanying drawings.

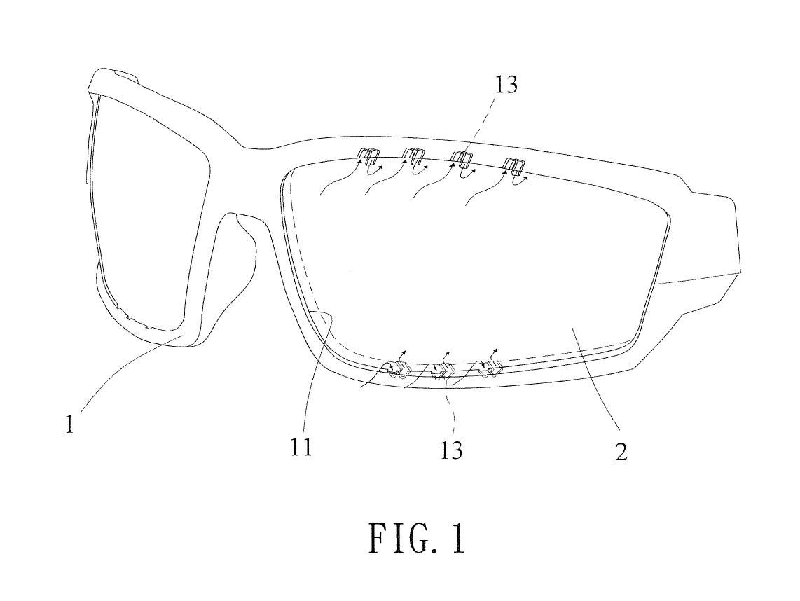

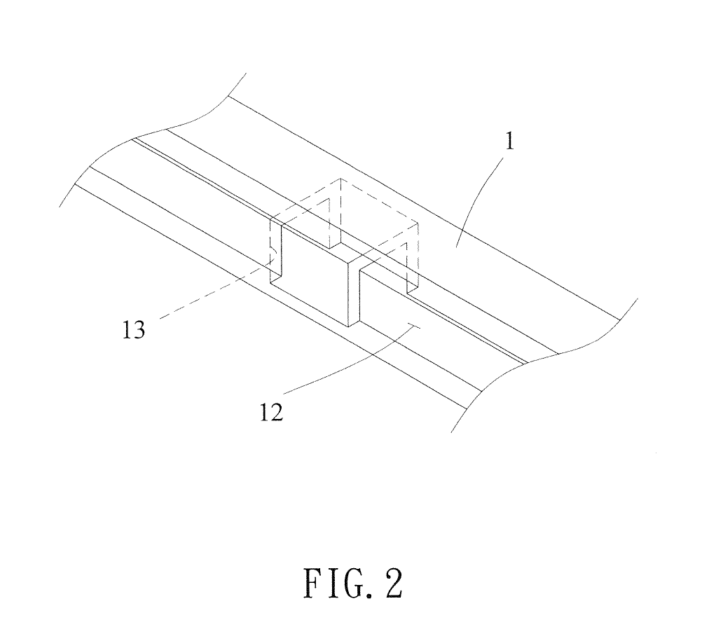

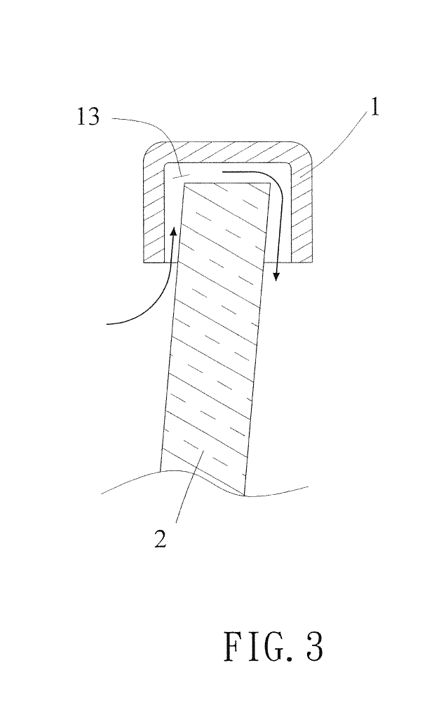

First, referring to FIG. 1 to FIG. 3, a ventilation structure of eyeglasses according to the present invention comprises a full-frame spectacle frame (1) having a lens assembly portion (11), a concave slot (12) extended from a peripheral edge of the lens assembly portion (11) for engaging with a lens (2), and a plurality of air guide channels (13) integrally formed in the concave slot (12), wherein each of the plurality of air guide channels (13) is extended from an opening of the concave slot (12), pass front and rear sidewalls of the concave slot (12) and towards a base of the concave slot (12).

Accordingly, shielded by the lens (2), users' eyes keep away from an attack of wind, snow, or foreign objects in activities, e.g. riding motorcycles and bicycles or skiing. In activities, hot vapors released from users' skin or breathing may cause different temperatures inside and outside the lens, resulting in fogging on the lens (2). In such a case, the plurality of air guide channels (13) extended from an opening of the concave slot (12) allow air outside the spectacle frame (1) to flow inside the spectacle frame (1), so as to maintain a same temperature inside and outside the lens (2) and to achieve effect of immediate defogging. Therefore, users can see the surroundings clearly and ensure their safety in activities.

In addition, because the plurality of air guide channels (13) is integrally formed in the concave slot (12), rainwater can hardly infiltrate into an inside of the spectacle frame (1). Users only need to wipe up rain or snow on the outside of the lens (2) without taking off the eyeglasses to clean the inner surface of the lens (2), which also causes much convenience when users are engaging in activities.

Furthermore, the plurality of air guide channels (13) is hidden in the concave slot (12), so an appearance of the eyeglasses equipped with a ventilation structure is identical to that of general eyeglasses. Therefore, users can wear the eyeglasses of the present invention not only in activities but also in usual, which saves costs of purchasing eyeglasses.

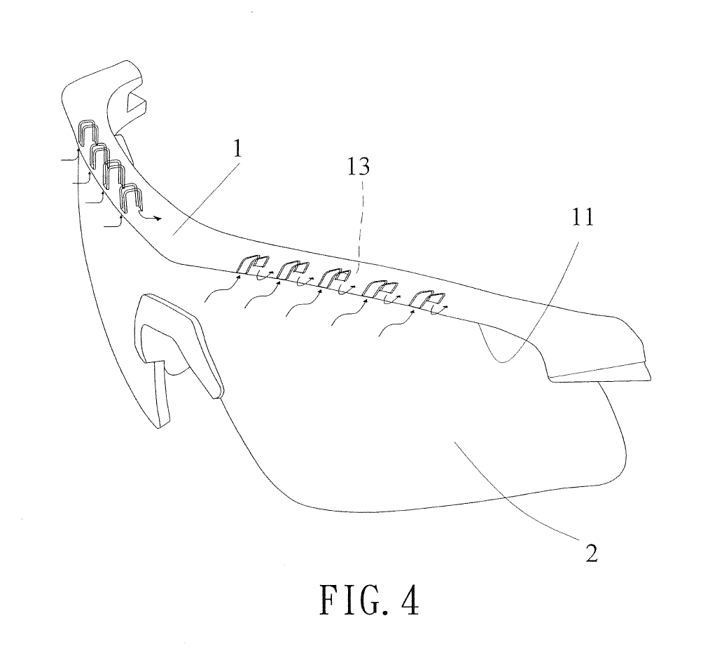

It is worth mentioning that a ventilation structure of eyeglasses of the present invention can be disposed on not only a full-frame spectacle frame (1) but also a half-frame spectacle frame (1) as shown in FIG. 4.

According to the above description, in comparison with the traditional technique, a ventilation structure of eyeglasses according to the present invention has the advantages as following:

1. The present invention has a plurality of air guide channels extended from an opening of the concave slot, which allows air outside the spectacle frame to flow inside the spectacle frame, so as to maintain a same temperature inside and outside the lens and to achieve effect of immediate defogging.

2. A plurality of air guide channels is hidden in the concave slot, so an appearance of the eyeglasses equipped with a ventilation structure is identical to that of general eyeglasses. Therefore, users can wear the eyeglasses of the present invention not only in activities but also in usual, which saves costs of purchasing eyeglasses.

3. Each of a plurality of air guide channels is integrally formed in a concave slot, so the rainwater is hard to infiltrates into an inside of the spectacle frame, which can keep clarity of sight and increase convenience in activities.

1. A ventilation structure of eyeglasses, comprising:
a spectacle frame having at least one lens assembly portion,
a concave slot extending along the lens assembly portion for engaging a peripheral edge of a lens, and
a plurality of air guide channels integrally formed in the concave slot, wherein each of the plurality of air guide channels forms a recess extended transversely across the concave slot from an opening of the concave slot, along front and rear sidewalls of the concave slot and towards a base of the concave slot.

2. The ventilation structure of eyeglasses as claimed in claim 1, wherein the spectacle frame is a full-frame spectacle frame.

3. The ventilation structure of eyeglasses as claimed in claim 1, wherein the spectacle frame is a half-frame spectacle frame.
